(19) United States
(12) Patent Application Publication
(10) Pub. No.: US 2007/0093193 A1
(43) Pub. Date: Apr. 26, 2007

(54) Energy efficient paint booth

(76) Inventors: Lawrence A. Cook, Commerce Township, MI (US); Lonnie M. Thelen, Ypsilanti, MI (US); Adrien de Borchgrave, Canton, MI (US); Gordon M. Harbison, Canton, MI (US); Mark A. Oliphant, Southgate, MI (US); Bruce Roesler, Wixom, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/487,668

(22) Filed: Jul. 17, 2006

Related U.S. Application Data
(60) Provisional application No. 60/729,676, filed on Oct. 24, 2005.

(51) Int. Cl. B05B 15/12

(52) U.S. Cl. 454/52

(57) ABSTRACT

A method of conditioning the air supplied to a paint application booth having a separate air supply from a paint application building housing the paint application booth includes determining a booth psychometric condition preferred to apply paint inside the paint application booth. Air is removed from the paint application building and conditioned obtaining the preferred booth psychometric condition of the air removed while maintaining a generally constant enthalpy. The air removed from the paint application building is transferred into the paint booth at the booth psychometric condition preferred to apply paint inside the paint application booth.

### RELATED APPLICATION

This application claims priority to Provisional Application Ser. No. 60/729,676 filed Oct. 24, 2005.

### FIELD OF THE INVENTION

The present invention relates generally toward an improved method for controlling the environment inside a paint booth. More specifically, the present invention relates toward an energy efficient method of using heat generated inside the paint application building to reduce the cost associated with conditioning the environment inside the paint application booth.

### BACKGROUND OF THE INVENTION

The operation of a paint application building, and more specifically, a paint application booth, has proven to be one of the most costly elements of mass producing articles that are coated with protective and/or decorative coatings. In a mass production setting, articles are conveyed through a paint application booth where atomized paint is applied to the article, such as, for example, automobile bodies, at a high rate. The increased use of environmentally friendly coating materials such as, for example, water borne base coats, urethane clear coats, and powder coatings has required a narrow psychometric condition be maintained inside the paint application booth during operation. This has resulted in increasing costs associated with achieving the preferred psychometric condition to achieve the necessary coating quality.

Presently configured paint application buildings generally make use of segregated ventilation systems for the paint application booth, working areas, and non-working or general building areas. In each case, fresh ambient air is drawn from the outside environment and treated by either heating, cooling, humidifying, or dehumidifying to obtain the desired psychometric condition. This is best represented in FIG. 1 where a conventional paint application building ventilation schematic is generally shown at 10. The conventional application building 10 generally includes three separate areas, namely, a general building or non-work area 12, a work space 14, and a paint application booth 16.

The general building area 12 includes all of the areas inside the building 10 where no significant work is performed on the articles being coated. This includes aisle ways, article accumulation areas, and article transport areas. The general building area 12 includes an independent air inlet 18 that draws air from outside the building 10 via a building air supply house 20. In Northern regions, this air is generally heated and humidified particularly during the Winter months, and in the Southern region, this air is generally cooled and dehumidified, particularly during the Summer months. The building 10 also includes a building exhaust 22 where air is generally, continuously exhausted from the general building area 12. Thus, air that has been conditioned in the building air supply house 20 by either heating, cooling, humidifying, and dehumidifying is exhausted back to atmosphere without making further use of the desired psychometric condition established in the building air supply house 20.

Various work spaces 14 are also included in a conventional paint building 10 where various functions are performed on the article being painted, both before and after paint application. Some of these functions include detacification, dust and other particle removal, both dry and wet sanding, sealer application, and other necessary operations to make ready the article to be painted. Each of these processes are known to increase air temperature inside the various work spaces 14. Each work space 14 includes a work space air inlet 24 that draws air into the work space 14 via a work space air supply house 26. Air is generally, continuously exhausted from the work space 14 through a work space exhaust 28. The temperature of the air exiting the work space 14 is typically greater than the air entering the work space 14 as the work being performed on the articles generates heat. This heat energy along with the energy used to condition air received from the work space air inlet 24 to reach the desired psychometric condition in the work space 14 is exhausted through the work space exhaust 28 to the atmosphere.

Air is delivered to the application booth 16 through a booth air inlet 30 via a booth air supply house 32. The psychometric condition of the air entering the application booth 16 is defined by the processing parameters of the coating material being applied to the article. Therefore, the energy used to condition the air received from the booth air inlet inside the booth air supply house 32 to heat, cool, humidify, and dehumidify is significantly greater and more precisely controlled than the conditioning that takes place in the building air supply house 20 and the work space air supply house 26. As stated previously, the air drawn through the booth air inlet 30 is generally heated and humidified in Northern regions primarily during the Winter months and cooled and dehumidified in Southern regions, primarily during the Summer months. The air flowing through the spray booth 16 is generally, continuously exhausted through a booth exhaust 34 where the energy used to condition the air is exhausted to the atmosphere.

The conventional paint building design set forth above has proven to use an excessive amount of energy to condition air for each of the building 12, the work space 14 and the application booth 16. In each case, air is exhausted to the atmosphere without taking full advantage of the energy used to condition the air to obtain the preferred psychometric condition in each of the various areas. Therefore, it would be desirable to provide a coating process having reduced energy requirements by taking advantage of more efficient flow of energy, particularly during an era of increasing energy costs.

### SUMMARY OF THE INVENTION

The present invention is directed toward a method of conditioning the air supply to a paint application booth disposed within a paint application building. A booth psychometric condition preferred to apply paint inside the paint application booth is determined based upon specifications set forth by the paint or coating supplier. Air is removed from the paint application building and is conditioned to obtain the preferred booth psychometric condition. The air is conditioned while maintaining a generally constant enthalpy and is transferred into the paint booth at the preferred booth psychometric condition.

The inventive method of conditioning the air supply to the paint application booth takes advantage of the psychometric condition of the air disposed in the paint building exterior to the paint booth. Generally, air makeup supplied to the paint application building is conditioned by either heating and humidifying and cooling and dehumidifying depending on the seasonal condition and the regional location of the building. Therefore, energy is used to condition the air received from the atmosphere to provide a building environment that is more conducive to processing articles through a paint booth than is the atmosphere. Furthermore, the mechanical operations and machinery generally provide heat energy to the air disposed inside the application building that results in an increase in temperature of the air. Prior art buildings partly vent this air to the atmosphere when circulating fresh air through the paint application building resulting in the loss of the heat energy provided to the air by virtue of the work functions performed inside the building and the energy associated with conditioning the air to make the building interior more conducive to processing the articles through the paint booth than is the atmosphere outside the building.

By taking advantage of the energy associated with the air inside the building and making use of the psychometric condition of the air disposed inside the building, a significant energy reduction is achieved by routing the building air through the paint application booth as opposed to exhausting the air from the building back to the atmosphere. Specifically, the preferred psychometric condition inside the paint application booth is obtained by merely converting the sensible heat of the air being transferred from the building to the application booth to latent heat. The preferred psychometric condition is obtained when converting sensible heat to latent heat by merely adding humidity to the flow of air from the application building through the paint application booth. This provides the opportunity to either eliminate cooling and heating systems associated with the paint application booth or significantly downsizing heating and cooling apparatus because the heat energy already disposed in the building air is being recycled.

### BRIEF DESCRIPTION OF THE DRAWINGS

FIG. 1 illustrates a cross sectional view of a prior art paint application building;

FIG. 2 illustrates a cross sectional view of a paint application building of the present invention;

FIG. 3 is a psychometric table representing an application booth of the present invention being operated at a target psychometric condition;

FIG. 4 is another psychometric chart representing a range of temperature and humidity known to produce equivalent paint quality; and

FIG. 5 illustrates an alternative embodiment of the paint application building.

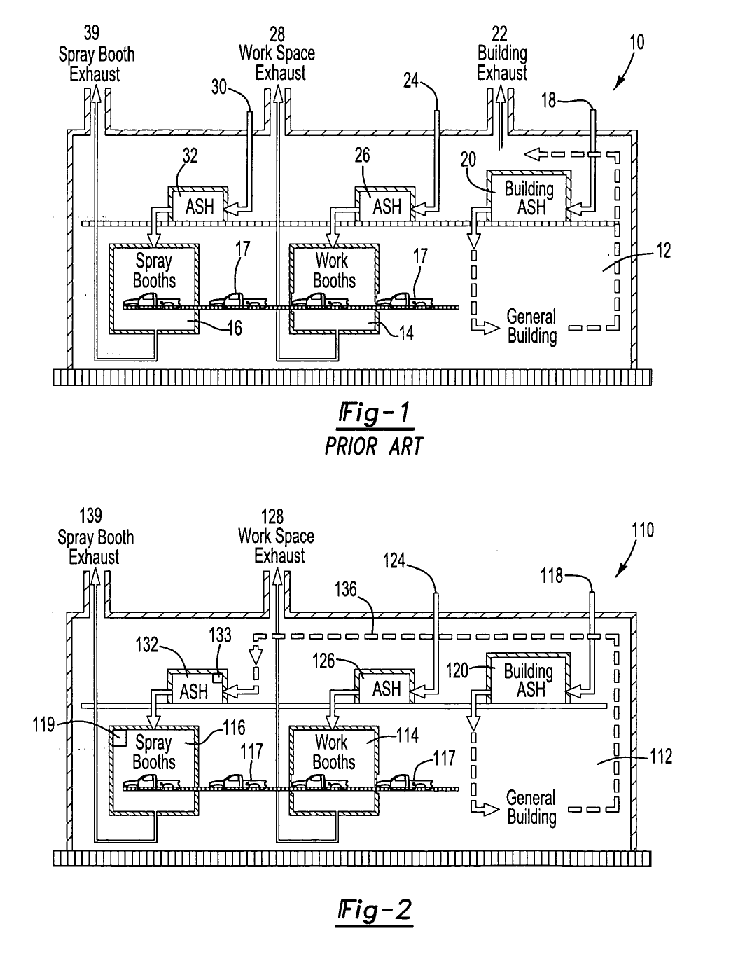

### DETAILED DESCRIPTION OF THE INVENTION

Referring to FIG. 2, a paint building of the present invention is generally shown at 110. The inventive paint building 110 generally includes a non-working or general building area 112, a work space 114 and an application booth 116. As is known to those of skill in the art, the general building area 112 includes aisle ways, office space, transfer conveyors, accumulators, and storage areas. The work spaces 114 are areas where additional work is performed on articles, such as, for example, vehicle bodies 117 being processed through the paint application building 110.

Many of the functions performed in the application building 110 and the work spaces 114 produce heat resulting in an increase in the air temperature within the work spaces 114. For example, unpainted vehicle bodies generally referred to as body in white are first treated with the application of a phosphate coating, which is applied at about 130° F. and is subsequently coated with an electrodeposition primer and baked at a temperature approaching 400° F. Each of these operations result in an increase in air temperature resulting in an altering of the psychometric condition of the air disposed in the work space 114. Further operations include sanding and cleaning the primered surface to remove particulate matter known to result in paint defects and also increase the temperature of the air in the work space 114.

The application booth 116 is maintained in the most precise psychometric condition out of any area in the paint application building 110. The type of paint being applied to the vehicle body 117 dictates a temperature and humidity range required to optimize the finished paint quality on the paint vehicle. For example, applying paint at an unrecommended high temperature or humidity may result in paint defects known as sags or orange peel on the vehicle body 117. Therefore, the paint supplier generally sets a humidity and temperature range known to reduce the potential for finish paint defects. Generally, the paint supplier recommends a target temperature and humidity known to produce optimum paint finish on the vehicle body 117. While a narrow range is also generally identified by a given paint supplier, it is recommended by that paint supplier that the target temperature and humidity be maintained at all times. It is contemplated by the inventors that the target temperature and humidity actually define a desirable range that provides an optimum paint application performance. It has also been contemplated by the inventors that the temperature and humidity target can be broadened along a line on a psychometric chart plotting dry bulb temperature against absolute humidity of air. The advantages of the present inventive paint building 110 are explained further below.

Ambient air is drawn through a building air inlet 118 from the atmosphere into a building air supply house 120 by fans sized and powered to produce the desirable amount of fresh air to the general building area 112. The building area supply house 120 includes air conditioning assemblies (not shown) that heat, cool, humidify, or dehumidify the air being drawn through the air inlet 118 from the atmosphere to the preferred temperature and humidity of the general building area 112.

Ambient air is also drawn from the atmosphere through a work booth air inlet 124 into a work booth air supply house 126 by fans (not shown) sized to provide the desired amount of fresh air to the various work booths 114 disposed within the paint application building 110. Like the building air supply house 120, the work booth air supply house 126 also includes air conditioning equipment to heat, cool, humidify, or dehumidify the air being drawn from the atmosphere 124 to the preferred temperature and humidity inside the various work booths 114. As represented in FIG. 2, the air from the work booth 114 is optionally vented through a work booth exhaust 128 to the atmosphere after appropriate abatement procedures are performed.

Air is drawn through a transfer 136 from the general building area 112 into a paint application booth air supply house 132 via fans sized to provide the desired amount of make up air to the application booth 116. The booth air supply house includes an air conditioner 133 to adjust the psychometric condition of the air entering the paint application booth 116, 216. The air conditioner 133 either increases the humidity, decreases the humidity, increases the temperature, or decreases the temperature of the air entering the paint application booth 116. As is known to those of skill in the art, this requires air conditioner to include a heater, chiller, humidifier, or dehumidifier. It is expected that the concepts of the present invention eliminates the need for a heat, or, in the alternative, enables the heater to be reduced in size. Air is exhausted from the application booth 116 through application booth exhaust 139 after the appropriate abatement is conducted in a known manner.

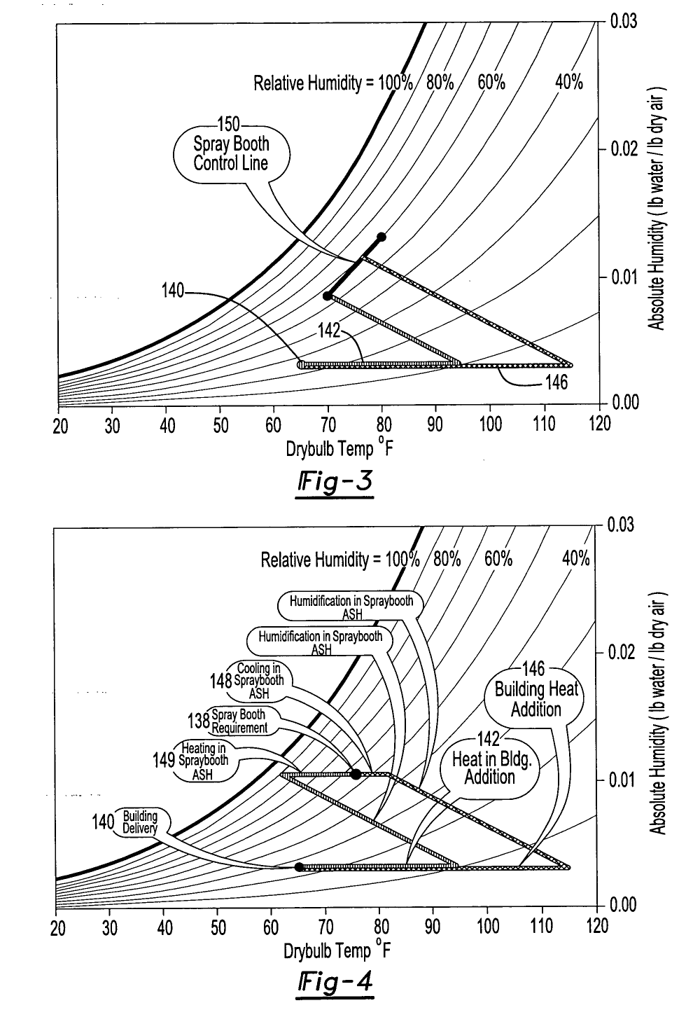

The method by which the advantages of the inventive paint building 110 is derived is best explained referring to a psychometric table set forth in FIG. 3. FIG. 3 represents the application booth 116 being operated at a target psychometric condition 138 (spray booth requirement). In this example, ambient air delivered through one of the general building air inlet 118 or the work space air inlet 124 is identified at dry bulb temperature and humidity at 140 (building delivery). It should be understood by those of skill in the art that the temperature and humidity of the ambient air 140 changes depending on seasonal and regional factors.

The first line on the psychometric chart in FIG. 3 represents heat added to the air in the general building area 112 and through operation of necessary equipment in the paint building 110. In this example, the ambient air temperature is increased from generally 65° F. to around 95° F. Converting the sensible heat disposed in the general building area 112 air to latent heat by merely increasing humidity of the air transfer from the general building area 112 to the application booth 116, the psychometric condition of the transferred air becomes closer to the desired spray booth psychometric condition 138. This reduces the amount of the heating required in the booth air supply house 132 as represented by line 144 of the psychometric chart shown in FIG. 3.

A second example is represented in the psychometric chart of FIG. 3 where the temperature of the air in the building is increased from point 140 along line 146 to approximately 115° F. As set forth above, the sensible heat is converted to latent heat by merely adding humidity to the air transferred through transfer 136 from the building 112, or more likely in this example, from the work area 114 to the application booth 116. At generally constant enthalpies, the air temperature remains higher than its required psychometric condition 138 in the application booth 116 requiring additional cooling in the booth air supply house 132 as represented by line 148 of the psychometric chart in FIG. 3.

It has been determined by the inventors that the booth requirement 138 shown in the psychometric table in FIG. 3 is achievable through a range of temperature and humidity known to produce equivalent paint quality. The range is represented in the psychometric chart shown in FIG. 4 by the spray booth control line 150. By adopting the spray booth control line 150 as a process control parameter, the necessity for adding heat or removing heat from the air being transferred into the application booth 116 through transfer 136 from the general building 112 or the work booth 114 is eliminated further reducing the cost associated with conditioning the air inside the application booth 116. The point identified in the psychometric chart of FIG. 4 as 140 increases in temperature along lines 142 and 146 depending upon the various processes being performed in the paint application building 110. In each case, humidity is added converting sensible heat to latent heat in the continuous flow of air flowing from the paint application building 110 to the application booth 116. As the spray booth control line 115 is adopted providing a range of enthalpies neither heat needs to be added nor removed further reducing the cost associated with conditioning the air being delivered to the application booth 150.

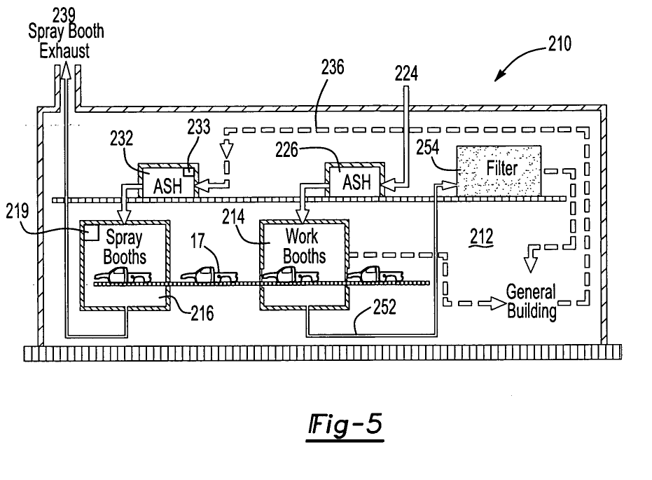

A further alternative embodiment of the paint application building as shown in FIG. 5 as 210. In this embodiment, a work space air inlet 224 provides air to the application building 210. Air is drawn through the work space air inlet 224 by fans disposed in a work space air supply house 226 for use in a work space area 214. As set forth above, heat is added to the air by virtue of the work being performed on the vehicle body 17 inside the work space 214. A work space transfer line 252 exhausts air from the work space 214 and may pass the air through a filtration system 254 before the air is introduced through the non-work area 212 of the application building 210. In this embodiment, air passes through transfer 236 after being exhausted from the non-work space 212 to the booth air supply house 232 via air supply fans (not shown). The psychometric condition of the air passing through the transfer 236 is determined prior to transferring the air into the application booth 216. As set forth above, the air is humidified in the booth air supply house 232 prior to transferring the air into the application booth 216. Air is continuously exhausted from the application booth through the application booth exhaust 239 where abatement is performed prior to releasing the booth air to the atmosphere. In this embodiment, costs are further reduced through the use of only a single exhaust 239 for the entire application building 210. It should be understood by those of skill in the art that fresh air may be added to the transfer 236 at a predetermined ratio for this and the previous embodiments if necessary.

The paint application booth 116, 216 of each of the embodiments set forth above include a sensor 119, 219 that signals a controller 121, 221 the temperature and humidity of the air inside the paint application booth 116, 216 to establish a feed back control loop. Preferably, the controller 121, 221 is a proportional integral derivative controller providing a level of control known to those of skill in the art to limit the amount of variability of the temperature and humidity in the paint application booth 116, 216. Therefore, the controller 121, 221 maintains the temperature and humidity inside the booth 116, 216 with the predetermined psychometric control range 150.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

1. A method of conditioning the air supplied to a paint application booth having a separate air supply from a paint application building housing said paint application booth, comprising the steps of:
determining a booth psychometric condition preferred to apply paint inside said paint application booth;
removing air from said paint application building;
conditioning the air removed from said paint application building thereby obtaining the preferred booth psychometric condition of the air removed from said paint application building while maintaining a generally constant enthalpy; and
transferring the air removed from said paint application building into said paint booth at the booth psychometric condition preferred to apply paint inside said paint application booth.

2. The method set forth in claim 1, further including the step of sensing the psychometric status prior to transferring the air removed from said application building into said paint application booth.

3. The method as set forth in claim 1, wherein said step of conditioning the air removed from said paint application building is further defined by adjusting the humidity of the air while maintaining a generally constant enthalpy.

4. The method set forth in claim 1, wherein said step of determining a booth psychometric property is further defined by establishing an enthalpy range capable of providing the booth psychometric condition.

5. The method as set forth in claim 1, wherein said step of conditioning the air removed from said paint application building is further defined by converting sensible heat disposed in the air to latent heat.

6. The method set forth in claim 1, wherein said step of removing air from said paint application building is further defined by removing air from a work area disposed inside said paint application building.

7. The method set forth in claim 1, wherein said step of removing air from said paint application building is further defined by removing air from a non-work area disposed inside said building.

8. The method set forth in claim 1, wherein said step of removing air from said paint application building is further defined by removing air from a work area and a non-work area.

9. The method set forth in claim 1, wherein said step of conditioning the air removed from said paint application building further includes the step of adjusting at least one of the temperature and the humidity of the air removed from said paint application building.

10. The method set forth in claim 1, further including the step of determining an enthalpy of the air disposed inside said paint application building external to said paint application booth and conditioning the air at a generally constant enthalpy to obtain the booth psychometric condition preferred to apply paint inside said paint application booth.

11. A method of maintaining the environmental condition of a paint application booth disposed inside a paint application building at a predetermined temperature and humidity; comprising the steps of:
providing a paint application booth air inlet for maintaining a continuous flow of air through said paint application booth;
providing a paint application building air inlet independent of said paint application booth air inlet;
providing a paint application building air exhaust for removing air from said paint application building;
interconnecting said paint application building air exhaust with said paint application booth air inlet for providing a continuous flow of air from said paint application building to said paint application booth; and
conditioning the air exhausted from said paint application building by converting sensible heat disposed in the continuous flow of air provided to said paint application booth from said paint application building to latent heat.

12. The method recited in claim 11, further including the step of measuring the humidity and temperature of the air exhausted from said paint application building.

13. The method recited in claim 12, further including the step of determining the enthalpy of the air exhausted from said paint application building.

14. The method recited in claim 11, further including the step of increasing the humidity of the air exhausted from said paint application building and continuously flowing to said paint application booth.

15. The method recited in claim 11, further including the step of determining a enthalpy range preferred for operating said paint application booth and converting the sensible heat disposed in the air flowing to said booth to obtain a latent heat generally consistent with the enthalpy range preferred for operating said paint application booth.

16. The method recited in claim 11, wherein said step of providing a paint a paint application building is further defined by providing a paint application building having working areas and non-working areas.

17. The method recited in claim 16, wherein said step of interconnecting said paint application building air exhaust with said paint application booth air inlet is further defined by interconnecting at least one of said working areas and said non-working areas to said paint booth air inlet.

18. A production paint application facility, comprising:
a paint application booth having a booth air supply for providing conditioned air to said paint application booth in a predetermined temperature and humidity range and a booth air exhaust for evacuating air from said paint application booth;
a building housing said paint application booth and having a building air supply for providing air to said building and a building exhaust for evacuating air from said building, said building exhaust being interconnected with said booth air supply for transferring air from said building into said paint application booth; and
a conditioning device providing a psychometric adjustment to the air transferred from said building to said paint application booth thereby conditioning the air transferred from said building to said paint application booth to the predetermined temperature and humidity range.

19. The facility set forth in claim 18, wherein said conditioning device comprises at least one of a humidifier, de-humidifier, heater, or chiller.

20. The facility set forth in claim 18, wherein said building includes work areas and non-work areas and said building exhaust comprises a transfer one of said work areas and said non-work areas.

21. The facility set forth in claim 20, wherein said building air supply comprises a single inlet providing fresh air to said work-area and said non-work area.

22. The facility set forth in claim 20, wherein said building air supply comprises a single air inlet providing fresh air sequentially to said work air and said non-work area.

23. The facility set forth in claim 18, including a transfer for transferring air from at least one of the work area or non-work area of the paint application building.

24. A method of providing air to a paint application booth disposed within a paint application building, comprising the steps of:
determining a psychometric control range providing optimized paint application properties;
transferring air from inside said paint application building into said paint application booth;
determining the humidity and temperature of the air inside said paint application booth;
adjusting at least one of the humidity and temperature of the air being transferred into said paint application booth from said paint application building in response to determining the humidity and temperature of the air inside said paint application booth thereby obtaining a psychometric condition inside said paint application booth within the psychometric control range providing optimized paint application properties.

25. The method set forth in claim 24, further including the step of establishing proportional integral derivative control of the air transferred into the paint application booth from said paint application building.

26. The method set forth in claim 24, wherein said step of adjusting at least one of the humidity and temperature of the air being transferred into said paint application booth is further defined by adjusting one of the humidity and temperature just prior to transferring air into said paint application booth from said paint application building.

27. The method set forth in claim 24, wherein said step of adjusting at least one of the temperature and humidity of the air being transferred into said paint application booth from said paint application building is further defined by identifying a point in said psychometric control range requiring a minimum amount of energy to obtain.

28. The method set forth in claim 24, further including the step of providing a proportional derivative controller to determine the humidity and temperature of the air inside said paint application booth.
